(19) United States
(12) Patent Application Publication
(10) Pub. No.: US 2012/0326661 A1
(43) Pub. Date: Dec. 27, 2012

(54) CONTACTLESS POWER RECEIVING DEVICE, AND CONTACTLESS CHARGING SYSTEM

(75) Inventors: Kyohei Kada, Kyoto (JP); Kazuhiro Suzuki, Shiga-ken (JP); Takaoki Matsumoto, Shiga-ken (JP); Yoshihide Kanakubo, Osaka (JP); Yohei Nagatake, Kanagawa-ken (JP); Yoshiyuki Konishi, Shiga-ken (JP)

(73) Assignees: Panasonic Corporation, Osaka (JP); Panasonic Electric Works Co., Ltd., Osaka (JP)

(21) Appl. No.: 13/582,255

(22) PCT Filed: Mar. 8, 2011
(86) PCT No.: PCT/JP2011/055312

§ 371 Date: Aug. 31, 2012

(30) Foreign Application Priority Data
Mar. 26, 2010 (JP) 2010-072990

(51) Int. Cl. H02J 7/00

(52) U.S. Cl. 320/108

(57) ABSTRACT

A contactless power-receiving device, which is connected to equipment via a connection terminal and which supplies power to the load for the equipment, provided with: a secondary coil which intersects the alternating magnetic flux generated from a primary coil to which an alternating power is supplied; and a control unit which supplies induced electromotive force of the secondary coil to the load. The control unit determines the amount of charge in the load and determines whether or not to supply power to the load on the basis of the determined amount of charge.

### RELATED APPLICATIONS

This application is the U.S. National Phase under 35 U.S.C. §371 of International Application No. PCT/JP2011/055312, filed on Mar. 8, 2011, which in turn claims the benefit of Japanese Application No. 2010-072990, filed on Mar. 26, 2010, the disclosures of which applications are incorporated by reference herein.

### TECHNICAL FIELD

The present invention relates to a contactless power receiving device, which transmits power between devices in a contactless manner using electromagnetic induction, and a contactless charging system including a contactless power receiving device.

### BACKGROUND ART

A contactless power transmitting device nowadays widely known as a device capable of charging, in a contactless manner, a rechargeable cell (battery) used in a portable device, such as a portable telephone, a digital camera, and the like. Such a portable device and charger (power transmitting device) corresponding to the portable device each includes a coil that sends and receives charging power. Electromagnetic induction between the two coils transmits AC power from the charger to the portable device. The portable device converts the AC power into DC power to charge the rechargeable battery, which is a power supply of the portable device. As described in, for example, patent document 1 and patent document 2, such a portable device include a charging control unit that monitors the charging amount of the rechargeable battery to determine and notifying the power transmitting side (primary side) whether charging can be performed and whether or not charging is necessary.
Patent Literature 1: Japanese Laid-Open Patent Publication No. 2008-178195
Patent Literature 2: Japanese Laid-Open Patent Publication No. 2008-206232

### SUMMARY OF INVENTION

However, not all portable devices include a charging control unit. For example, a charging control unit may not be included when the portable device is sold overseas or manufactured by a different manufacturer. Further, the charger may be sold separately (solely) from the portable device. Thus, when charging a portable device that does not include a charging control unit with a charger that functions under the assumption that the portable device includes a charging control unit, the charging amount of the rechargeable battery may not be recognized, and charging may not be performed normally.

Accordingly, it is an object of the present invention to provide a contactless power receiving device and a contactless charging system that can perform charging normally.

To achieve the above object, a first aspect of the present invention is a contactless power receiving device connected by a connection terminal to a device or equipment. The contactless power receiving device supplies power to a load of the equipment. The contactless power receiving device includes a secondary coil that intersects with an alternating magnetic flux generated from a primary coil, which is supplied with AC power. A control unit supplies induced electromotive force of the secondary coil to the load. The control unit determines a charging amount of the load and determines whether or not to supply power to the load based on the determined charging amount.

A second aspect of the present invention is a contactless charging system provided with a contactless power transmitting device, which includes a primary coil that generates an alternating magnetic flux when supplied with AC power, and a contactless power receiving device, which includes a secondary coil that intersects with the alternating magnetic flux generated from the primary coil. The contactless power receiving device supplies the AC power, which is supplied from the primary coil through the secondary coil, to a load of a device or equipment connected by a connection terminal. The contactless power receiving device includes a control unit that supplies the load with an induced electromotive force of the secondary coil generated by intersecting the alternating magnetic flux generated from the primary coil. The control unit determines a charging amount of the load and determines whether or not to supply power to the load based on the determined charging amount.

### BRIEF DESCRIPTION OF DRAWINGS

FIG. 1(a) is a block diagram showing a contactless charging system and a portable device main body that includes a charging management unit, and FIG. 1(b) is a block diagram showing a contactless charging system and a portable device main body that does not include the charging management unit.

FIG. 2 is a schematic view showing a contactless power receiving device and the portable device main body.

FIG. 3 is a circuit diagram showing a monitoring circuit.

FIG. 4 is a flowchart showing a flow of processes during charging.

FIGS. 5(a) to 5(n) are schematic views showing the waveform of power flowing to a primary coil and a waveform of a power flowing to a secondary coil.

### DESCRIPTION OF EMBODIMENTS

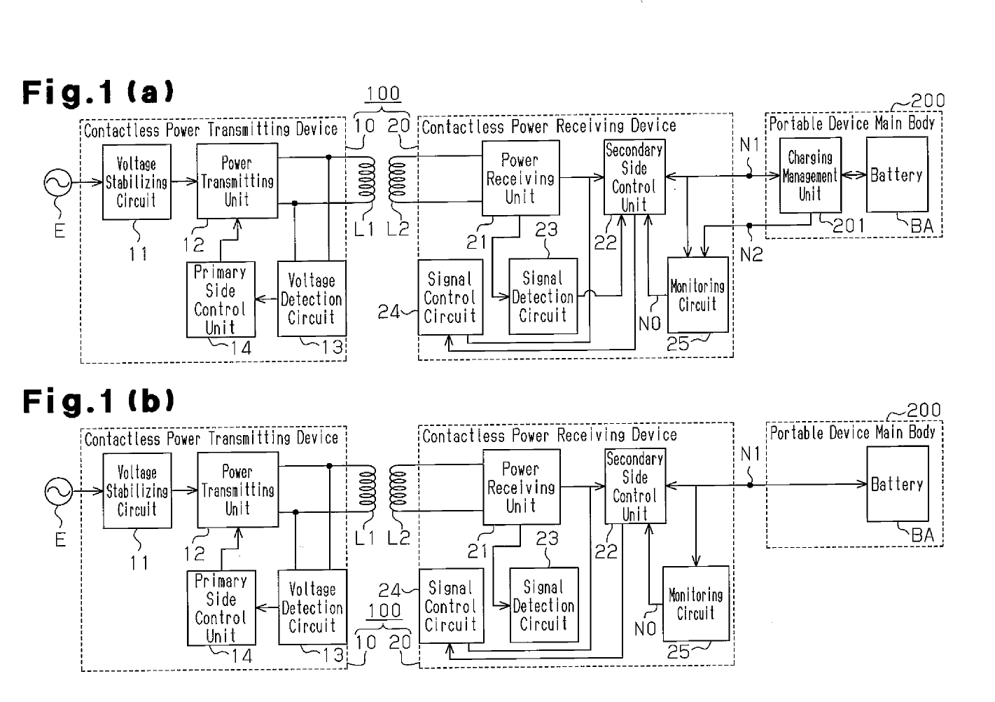

One embodiment of a contactless charging system according to the present invention will now be described with reference to the drawings. FIG. 1 is a block diagram showing the structure of a contactless charging system 100 and a portable device main body (device or equipment) 200, which is connected to the contactless charging system 100 and includes a battery BA that is charged, in the present embodiment.

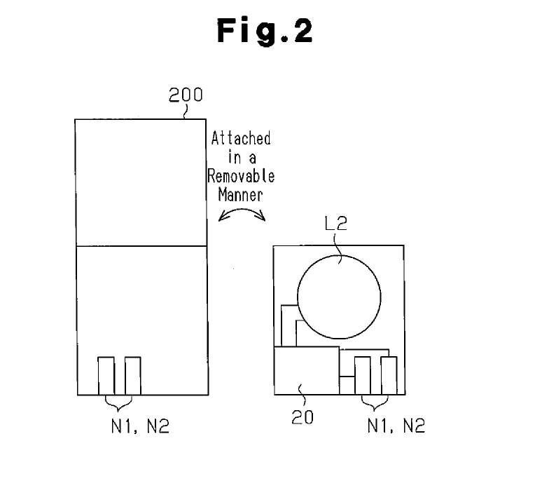

As shown in FIG. 1, the contactless charging system 100 is roughly divided into a contactless power transmitting device 10, which is connected to an external power supply E, and a contactless power receiving device 20, which receives power in a contactless manner from the contactless power transmitting device 10. As shown in FIGS. 1 and 2, the portable device main body 200 is configured to be electrically connectable to the contactless power receiving device 20 through connection terminals N1 and N2. In the present embodiment, the contactless power receiving device 20 is formed as a battery cover of the portable device main body 200 and attached in a removable manner to the portable device main body 200.

The contactless power transmitting device 10 will now be with reference to FIG. 1.

The contactless power transmitting device 10 includes a voltage stabilizing circuit 11, a power transmitting unit 12, a primary coil L1, a voltage detection circuit 13, and a primary side control unit 14.

The voltage stabilizing circuit 11 is a circuit for stabilizing the voltage of input power received from the external power supply E. The power transmitting unit 12 is connected to the voltage stabilizing circuit 11. When transmitting power, the power transmitting unit 12 generates AC power having a predetermined frequency. Further, when transmitting a signal, the power transmitting unit 12 generates AC power of a frequency corresponding to the transmitted signal and outputs the power to the primary coil L1 connected to the power transmitting unit 12. The power transmitting unit 12 generates and outputs AC power having frequency f1 when outputting a signal corresponding to data “1” and generates and outputs AC power having frequency f2 when outputting a signal corresponding to data “0”.

The primary coil L1 generates an alternating magnetic flux having a frequency corresponding to the frequency of the AC power when the AC power is input. The primary coil (power transmitting side coil) L1 electromagnetically couples with a secondary coil (power receiving side coil) L2 to transmit power. The voltage detection circuit 13 is a circuit for detecting an induced electromotive force (voltage) of the primary coil L1. The voltage detection circuit 13 is connected to the primary side control unit 14 and outputs the waveform of the detected induced electromotive force (voltage) to the primary side control unit 14.

The primary side control unit 14 is mainly formed by a microcomputer including a central processing unit (CPU) and a storage device (nonvolatile memory (ROM), volatile memory (RAM), etc.) and executes various types of controls such as oscillation control of the power transmitting unit 12 based on various types of data and programs stored in the memory.

More specifically, the primary side control unit 14 is connected to the power transmitting unit 12. When the contactless power transmitting device 10 transmits a signal to the contactless power receiving device 20, the primary side control unit 14 notifies the power transmitting unit 12 of the signal that is to be transmitted (or frequency corresponding to the signal that is to be transmit) so that the power transmitting unit 12 generates AC power having the frequency corresponding to the signal that is to be transmitted.

The primary side control unit 14 measures changes in the induced electromotive force of the primary coil L1 received from the voltage detection circuit 13 to perform signal detection, foreign substance detection, and the like. For instance, when a signal control circuit 24 of the contactless power receiving device 20 executes a load modulation process to transmit a signal to the contactless power transmitting device 10, the waveform of the induced electromotive force of the primary coil L1 changes. More specifically, when the contactless power receiving device 20 reduces load to transmit the signal of “0”, the amplitude of the signal waveform of the induced electromotive force of the primary coil L1 becomes small. When the contactless power receiving device 20 increases load to transmit the signal of “1”, the amplitude of the signal waveform becomes large. Accordingly, the primary side control unit 14 can determine the type of a signal by checking whether or not the peak voltage of the induced electromotive force has exceeded a threshold value. The primary side control unit 14 of the present embodiment demodulates a wireless communication signal from the contactless power receiving device 20. Based on the analysis result, the primary side control unit 14 analyzes the demodulated signal to control the oscillation (frequency) of the power transmitting unit 12. The ROM stores in advance various threshold values and various types of parameters, which are necessary for demodulation of the wireless communication signal transferred with the contactless power receiving device 20, as will be described later in detail, analysis of the demodulated signal, and the like.

The contactless power receiving device 20 will now be with reference to FIG. 1.

The contactless power receiving device 20 includes the secondary coil L2, which receives the alternating magnetic flux from the contactless power transmitting device 10, a power receiving unit 21, a secondary side control unit 22, a signal detection circuit 23, and a signal control circuit 24.

When the secondary coil L2 receives the alternating magnetic flux, the power receiving unit 21 includes a rectifier circuit that converts the AC power (induced electromotive force) flowing to the secondary coil L2 into DC power. The rectifier circuit includes a rectifier diode and a smoothing capacitor, which smoothes the power rectified by the rectifier diode, and is configured as the so-called half-wave rectifier circuit that converts AC power input from the secondary coil L2 into DC power. The configuration of the rectifier circuit is just one example of a rectifier circuit that converting AC power into DC power and is not limited to such a configuration. The rectifier circuit may have the configuration of a full-wave rectifier circuit using a diode bridge or other well-known rectifier circuits. The signal detection circuit 23 is a circuit that detects the induced electromotive force of the secondary coil L2. The signal detection circuit 23 is connected to the secondary side control unit 22 to output the waveform of the detected induced electromotive force (voltage) to the secondary side control unit 22.

When transmitting the signal from the contactless power receiving device 20 to the contactless power transmitting device 10, the signal control circuit 24 performs a load modulation process that changes the load applied to the secondary coil L2 in accordance with the signal that is to be transmitted to change the signal waveform of the induced electromotive force of the primary coil L1. The signal control circuit 24 is connected to the secondary side control unit 22 to execute the load modulation process based on a control signal from the secondary side control unit 22.

The secondary side control unit 22 is mainly formed by a microcomputer including a central processing unit (CPU) and a storage device (ROM, RAM, etc.). The secondary side control unit 22 can determine the state of charge of the battery BA of the portable device main body 200, which is connected by the connection terminals N1 and N2, and can execute various controls such as charging amount control based on the various types of data and programs stored in the memory. In the present embodiment, signals sent to the contactless power transmitting device 10 are generated based on the charging amount of the battery BA. The ROM stores in advance various types of information required for the charging amount control such as determination of the charging amount of the battery (present load) BA, various types of parameters required for the generation of signals transferred to the contactless power transmitting device 10 and form the modulation based on such signals, and the like.

A positive electrode and a negative electrode of the battery BA are each electrically connected to the secondary side control unit 22 to receive drive power from the battery BA. The secondary side control unit 22 adjusts the AC power input from the power receiving unit 21 to a predetermined voltage to generate the charging power and outputs the charging power to the battery BA via the connection terminals N1 and N2. The secondary side control unit 22 determines whether or not to output the charging power in accordance with the charging amount of the battery BA. For instance, the secondary side control unit 22 supplies the charging power to the battery BA when determining that it is preferable that the battery BA be charged due to the voltage between the terminals of the battery BA being lower than a charging amount determination threshold value, which is set in advance, or the like. The secondary side control unit 22 does not supply the charging power to the battery BA when determining that the battery BA does not need to be charged due to the voltage between the terminals of the battery BA being higher than the charging amount determination threshold value or the like.

The secondary side control unit 22 stops the output of the charging power when transmitting and receiving signals to and from the contactless power transmitting device 10. Further, the secondary side control unit 22 electrically disconnects the battery BA to prevent a back flow of the power from the battery BA when an operation voltage is lower than an operable voltage.

The secondary side control unit 22 monitors the waveform of the induced electromotive force of the secondary coil L2 to determine whether or not the positional relationship of the primary coil L1 and the secondary coil L2 is appropriate. The secondary side control unit 22 also monitors the frequency of the induced electromotive force of the secondary coil L2 to determine whether the signal from the contactless power transmitting device 10 is data “1” or data “0”.

In the present embodiment, the portable device main body 200 is configured to be attached in a removable manner to the contactless power receiving device 20, as shown in FIG. 2. Normally, the portable device main body 200 may include (see FIG. 1(a)) or may not include (see FIG. 1(b)) a charging management unit (device side charging control unit 201) that determines the charging state of the battery BA and performs charging amount control for the battery BA. Thus, a monitoring circuit 25 is connected to the secondary side control unit 22 of the present embodiment to recognize the charging amount of the battery BA of the connected portable device main body 200 and to give priority to the control execute by the charging management unit 201 when the portable device main body 200 includes the charging management unit 201.

The monitoring circuit 25 is connected to the secondary side control unit 22 and configured to be connectable to the charging management unit 201 via the connection terminals N1 and N2. The monitoring circuit 25 may input a charging completion signal, which is output from the charging management unit 201, when the voltage of the battery BA is greater than or equal to a full charge determination value (second full charge determination value), which is set in advance in the portable device main body 200. The charging completion signal is a signal indicating that the charging amount is sufficient and that charging is not necessary (fully charged state). The monitoring circuit 25 outputs the charging completion signal to the secondary side control unit 22 when the charging completion signal is input from the charging management unit 201. The secondary side control unit 22 executes the charging amount control based on the charging completion signal.

The monitoring circuit 25 may input a recharging request signal, which is output from the charging management unit 201, when the voltage of the battery BA is less than or equal to a recharge determination value (second recharge determination value), which is set in advance in the portable device main body 200. The recharging request signal is a signal indicating that the charging amount is insufficient and that charging is necessary (rechargeable state). The monitoring circuit 25 outputs the recharging request signal to the secondary side control unit 22 when the recharging request signal is input from the charging management unit 201. The secondary side control unit 22 executes the charging amount control based on the recharging request signal.

The monitoring circuit 25 is electrically connected by the connection terminals N1 and N2 to the positive electrode and the negative electrode of the battery BA to recognize the voltage of the battery BA. Thus, when the charging completion signal and the recharging request signal are not input from the charging management unit 201 of the portable device main body 200, in lieu of the charging management unit 201, the monitoring circuit 25 outputs the charging completion signal and the recharging request signal to the secondary side control unit 22 based on the voltage of the battery BA. In other words, the monitoring circuit 25 outputs the charging completion signal to the secondary side control unit 22 when the voltage of the battery BA is greater than or equal to a full charge determination value (first full charge determination value) set in advance in the contactless power receiving device 20. Further, the monitoring circuit 25 outputs the recharging request signal to the secondary side control unit 22 when the voltage of the battery BA is less than or equal to a recharge determination value (first recharge determination value), which is set in advance in the contactless power receiving device 20.

In the present embodiment, the first full charge determination value (e.g., 4.5 V) is set to a value that is greater than the second full charge determination value (e.g., 4.2 V). Thus, when the charging management unit 201 is connected, the charging management unit 201 can output the charging completion signal before the monitoring circuit 25. In the present embodiment, the first recharge determination value (e.g., 3.2 V) is set to a value that is less than the second recharge determination value (e.g., 3.8 V). Thus, when the charging management unit 201 is connected, the charging management unit 201 can output the recharging request signal before the monitoring circuit 25.

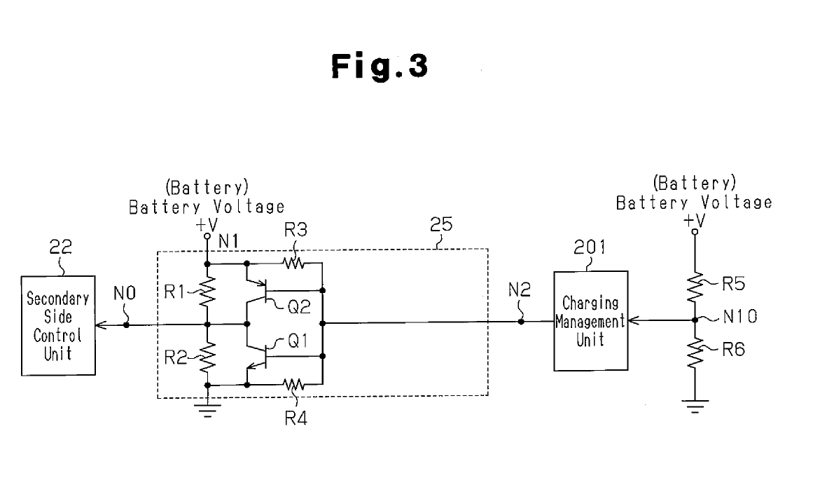

One example of a circuit configuration of the monitoring circuit 25 will now be specifically described with reference to FIG. 3. As shown in FIG. 3, the monitoring circuit 25 includes a resistor R1 having one end connected to the positive electrode of the battery BA through the connection terminal N1 and another end connected to a node N0. One end of a resistor R2 is connected to the node N0, and the other end of the resistor R2 is connected to ground. The secondary side control unit 22 is connected to the node N0 and receives the voltage divided by the resistors R1 and R2.

An emitter terminal of a (PNP type) transistor Q2 is connected to the positive electrode of the battery BA through the connection terminal N1. A collector terminal of the transistor Q2 is connected to the node N0. A base terminal of the transistor Q2 is connected to the charging management unit 201 through the connection terminal N2. The emitter terminal of the transistor Q2 is connected to the base terminal of the transistor Q2 and the connection terminal N2 of the charging management unit 201 through a resistor R3. The monitoring circuit 25 receives the charging completion signal from the charging management unit 201 through the connection terminal N2.

A collector terminal of a (NPN type) transistor Q1 is also connected to the node N0. An emitter terminal of the transistor Q2 is connected to the ground. A base terminal of the terminal Q1 is connected to the charging management unit 201 through the connection terminal N2. The emitter terminal of the transistor Q1 is connected to the base terminal of the transistor Q1 and the connection terminal N2 of the charging management unit 201 through a resistor R4. The monitoring circuit 25 receives the recharging request signal from the charging management unit 201 through the connection terminal N2.

As shown in FIG. 3, a resistor R5, which has the same resistance value as the resistor R3, includes one end connected to the positive electrode of the battery BA and another end connected to a node N10. A resistor R6, which has the same resistance value as the resistor R4, includes one end connected to the node N10 and another end connected to ground. The charging management unit 201 is connected to the node N10 and receives a divided voltage from the node N10.

The operation of the monitoring circuit 25 will now be described.

A case in which the charging management unit 201 is connected (present) through the connection terminals N1 and N2 will be described. When the voltage of the battery BA becomes greater than or equal to the second full charge determination value, the charging management unit 201 switches and connects the connection terminal N2 to ground. As a result, the transistor Q2 is activated and the voltage of the battery BA is input to the secondary side control unit 22 without being divided by the resistors R1 and R2. The voltage of the battery BA is thus directly input to the secondary side control unit 22 without being divided. The secondary side control unit 22 determines that the input voltage is greater than or equal to the first full charge determination value and determines that the charging is completed.

Thus, in the present embodiment, the charging completion signal is output by the charging management unit 201 when the charging management unit 201 connects the connection terminal N1 to ground and activates the transistor Q2. Further, when the monitoring circuit 25 continues to output the voltage of the battery BA, the output of the charging completion signal by the monitoring circuit 25 is based on the instruction of the charging management unit 201.

When the voltage of the battery BA becomes less than or equal to the second recharge determination value, the charging management unit 201 causes current to flow to the connection terminal N2. This activates the transistor Q1 and connects the node N0 to ground. That is, the secondary side control unit 22 is connected to ground. Accordingly, the secondary side control unit 22 determines that the input voltage is less than or equal to the first recharge determination value and requests for charging.

Thus, in the present embodiment, when the charging management unit 201 activates the transistor Q1, the charging management unit 201 outputs the recharging request signal. Further, when the monitoring circuit 25 connects the node N0 to ground, the monitoring circuit 25 outputs the recharging request signal based on an instruction from the charging management unit 201.

A case in which the charging management unit 201 is not connected (not present) will now be described. The voltage of the battery BA divided by the resistors R1 and R2 is input to the secondary side control unit 22. The secondary side control unit 22 determines whether or not the input voltage of the battery BA is greater than or equal to the first full charge determination value to determine whether or not the battery BA is in a fully charged state. Accordingly, when voltage that is greater than or equal to the first full charge determination value is output, the monitoring circuit 25 outputs the charging completion signal. The secondary side control unit 22 determines whether or not the input voltage of the battery BA is less than or equal to the first recharge determination value to determine whether or not the battery BA is in the rechargeable state. Accordingly, when voltage that is less than or equal to the first recharge determination value is output, the monitoring circuit 25 outputs the recharging request signal.

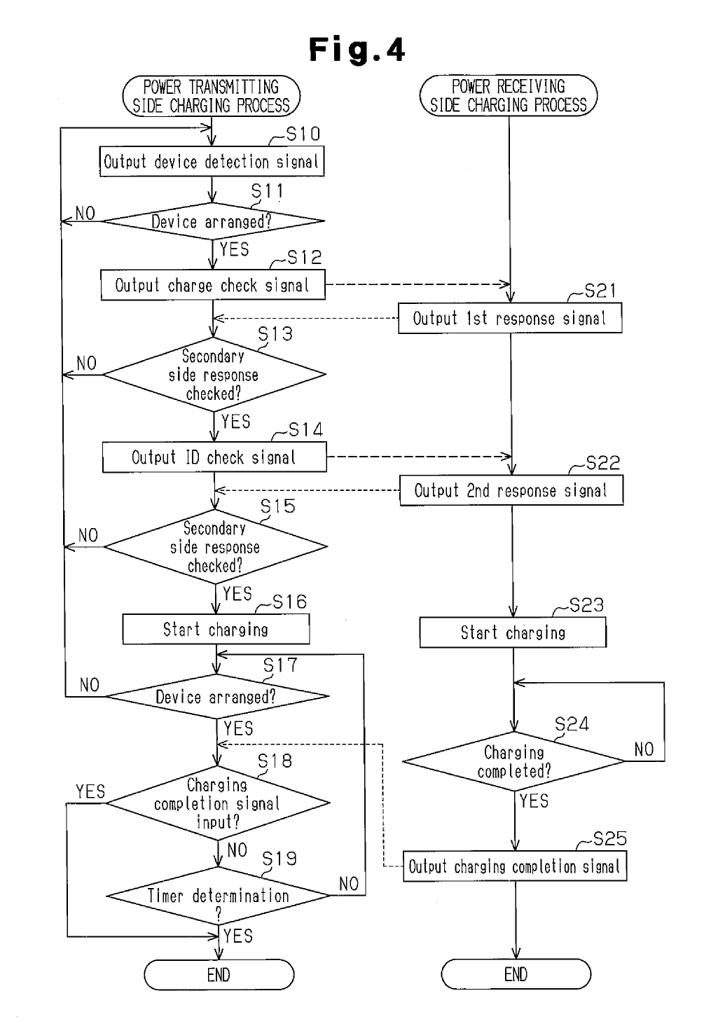

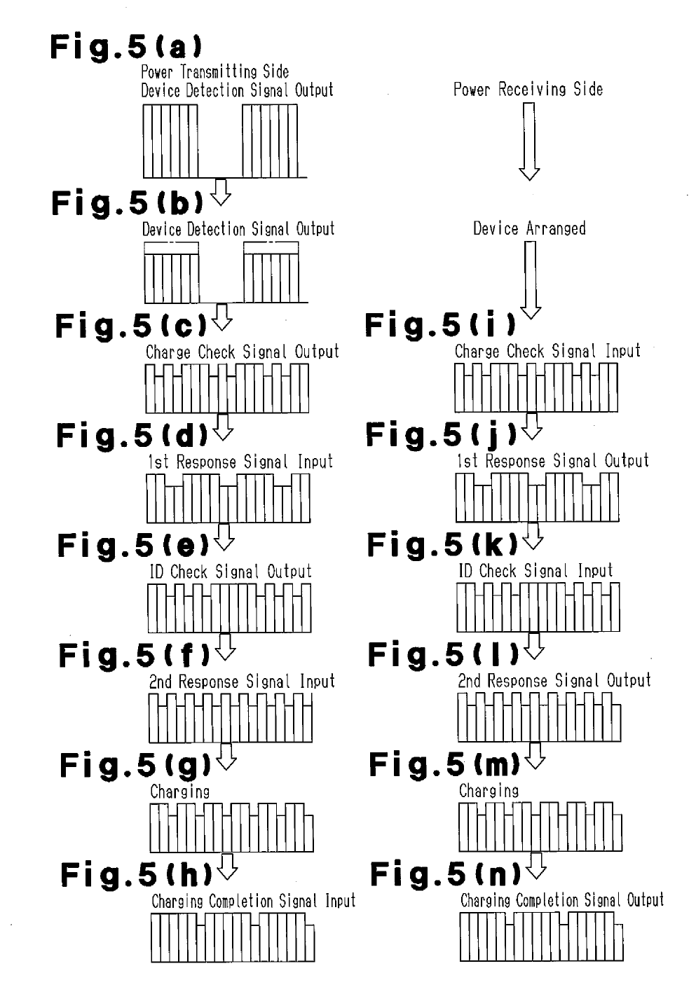

The control related to the charging of the battery BA will now be described. First, a case in which the portable device main body 200 does not include the charging management unit 201 will now be described with reference to FIGS. 4 and 5.

When in a standby state (not electromagnetically connected to the contactless power receiving device 20), the primary side control unit 14 outputs a device detection signal in predetermined detection cycles (step S10). As shown in FIG. 5(a), the device detection signal is intermittently output. The power for transmitting the device detection signal per unit time is smaller than the power for transmitting charging power (during charging) and the power for transmitting the signal of data “0” or “1”.

The contactless power transmitting device 10 outputs the device detection signal and executes a device arrangement determination to determine the arrangement of the contactless power receiving device 20 (step S11). In more detail, when the contactless power transmitting device 10 is in the standby state, if the contactless power receiving device 20 is arranged at a predetermined location and the primary coil L1 and the secondary coil L2 are electromagnetically coupled, the secondary coil L2 affects the primary coil L1 and changes the waveform of the device detection signal, as shown in FIG. 5(b). More specifically, the peak voltage in the AC power of the primary coil L1 when the device detection signal is output becomes small. Accordingly, the primary side control unit 14 determines (positive determination) the arrangement of the contactless power receiving device 20 when the waveform of the device detection signal is changed in the device arrangement determination. The primary side control unit 14 determines (negative determination) that the contactless power receiving device 20 is not arranged when a constant time elapses without the waveform of the device detection signal changing in the device arrangement determination.

When a negative determination is made in the device arrangement determination (step S11), the primary side control unit 14 executes the process of step S10 again after a predetermined time elapse and outputs the device detection signal again. When a positive determination is made in the device arrangement determination (step S11), the primary side control unit 14 outputs a charge check signal to the contactless power receiving device 20 (step S12). When outputting the charge check signal, the primary side control unit 14 controls the power transmitting unit 12 to convert (modulate) the charge check signal into the combination of signal “0” or “1” and sequentially output the converted signal, as shown in FIG. 5(c). As a result, the waveform of the induced electromotive force of the secondary coil L2 is changed in accordance with the charge check signal, as shown in FIG. 5(i).

The secondary side control unit 22 demodulates and analyzes the signal including “0” or “1” detected by the signal detection circuit 23. When determining that the charge check signal has been received, the secondary side control unit 22 determines the charging amount based on the voltage of the battery BA. Under the assumption that the charging management unit 201 does not include the portable device main body 200, the secondary side control unit 22 determines whether or not the voltage of the battery BA input through the monitoring circuit 25 is less than or equal to the first recharge determination value. When charging is possible (when the voltage of the battery BA is less than or equal to the first recharge determination value), the secondary side control unit 22 outputs a first response signal (recharging request signal) in correspondence with the charge check signal to the secondary coil L2 (step S21). Specifically, the secondary side control unit 22 changes the load applied to the secondary coil L2 to output the first response signal to the signal control circuit 24, as shown in FIG. 5(j). This changes the voltage of the induced electromotive force of the primary coil L1, as shown in FIG. 5(d). When charging is not necessary (when the voltage of the battery BA is greater than or equal to the threshold value), the secondary side control unit 22 ends the process without outputting the first response signal.

The primary side control unit 14 demodulates the signal based on the waveform of the induced electromotive force detected by the voltage detection circuit 13 and determines whether or not the first response signal is input (i.e., checks whether or not a signal is returned from the contactless power receiving device 20) (step S13). When the determination result is negative (when charging is unnecessary or when not electromagnetically connected), the primary side control unit 14 executes the process of step S10 again after a predetermined time elapses.

When the determination result of step S13 is positive (when receiving the first response signal), the primary side control unit 14 outputs an ID check signal, which indicates an ID to perform an ID authentication (step S14). The process of outputting the ID check signal is similar to the process of outputting the charge check signal. Specifically, when outputting the ID check signal, the primary side control unit 14 converts (modulates) the ID check signal to the combination of signal “0” or “1” and controls the power transmitting unit 12 to sequentially output the converted signal, as shown in FIG. 5(e). As a result, the waveform of the induced electromotive force of the secondary coil L2 is changed in accordance with the ID check signal, as shown in FIG. 5(k).

The secondary side control unit 22 demodulates and analyzes the signal including “0” or “1” detected by the signal detection circuit 23. When determining that the ID check signal is received, the secondary side control unit 22 determines whether or not the ID is that of the chargeable device (contactless power transmitting device 10). When the ID is that of the chargeable device (when ID authentication is completed (successful)), the secondary side control unit 22 outputs a second response signal in correspondence with the ID check signal (step S22). Specifically, the secondary side control unit 22 changes the load applied to the secondary coil L2 to output the second response signal to the signal control circuit 24, as shown in FIG. 5(l). This changes the voltage of the induced electromotive force of the primary coil L1, as shown in FIG. 5(f). When the ID authentication is unsuccessful (not chargeable device), the secondary side control unit 22 ends the process without outputting the second response signal.

The primary side control unit 14 demodulates the signal based on the waveform of the induced electromotive force detected by the voltage detection circuit 13 and determines whether or not the second response signal is input (i.e., checks whether or not a signal is returned from the contactless power receiving device 20) (step S15). When the determination result is negative (when the ID authentication is unsuccessful), the primary side control unit 14 executes the process of step S10 again after a predetermined time elapses.

When the determination result of step S15 is positive (when the second response signal is received), the primary side control unit 14 inputs the power for transmitting charging power to the primary coil L1 to start charging (step S16). The power for transmitting charging power is greater than the power for outputting the device detection signal output and is continuously output. The secondary side control unit 22 controls the voltage of the DC power input through the secondary coil L2 and the power receiving unit 21 after outputting the second response signal to generate charging power having a predetermined voltage and supply the charging power to the battery BA through the connection terminals. The secondary side control unit 22 then starts the charging (step S23).

After the charging starts, the secondary side control unit 22 continues to monitor the charging amount and determines whether or not the charging is completed based on the voltage of the battery BA input from the monitoring circuit 25 (step S24). Specifically, the secondary side control unit 22 determines whether or not the voltage of the battery BA is greater than or equal to the first full charge determination value. When the determination result of step S24 is negative (when charging is not completed), the secondary side control unit 22 executes the process of step S24 again after a predetermined time elapses.

When the determination result of step S24 is positive (if charging is completed), the secondary side control unit 22 outputs the charging completion signal indicating that the charging is completed (step S25). Specifically, the secondary side control unit 22 changes the load applied to the secondary coil L2 to output the charging completion signal to the signal control circuit 24, as shown in FIG. 5(n). This changes the voltage of the induced electromotive force of the primary coil L1, as shown in FIG. 5(h).

After the process of step S16 (after starting charging), the primary side control unit 14 executes the device arrangement determination that determines whether or not the contactless power receiving device 20 is still remaining (step S17). More specifically, when the contactless power receiving device 20 is removed from the predetermined location when the contactless power transmitting device 10 is in the charging state, the electromagnetic coupling of the primary coil L1 and the secondary coil L2 is released, and the waveform of the power of the primary coil L1 that flows during the charging is changed. Specifically, the peak voltage of the power of the primary coil L1 that flows during the charging changes and becomes large. Accordingly, in the device arrangement determination of step S17, the primary side control unit 14 determines (negative determination) that the contactless power receiving device 20 has been removed when the waveform of the power of the primary coil L1 that flows during the charging changes. The primary side control unit 14 determines (positive determination) that the contactless power receiving device 20 is still remaining when a constant time has elapsed without any changes in the waveform of the power of the primary coil L1 that flows during the charging in the device arrangement determination of step S17.

When the device arrangement determination of step S17 is negative, the primary side control unit 14 proceeds to the process of step S10. When the device arrangement determination of step S17 is positive, the primary side control unit 14 determines whether or not the charging completion signal is input (step S18). Specifically, in the process of step S18, the primary side control unit 14 demodulates the signal based on the waveform of the induced electromotive force detected by the voltage detection circuit 13 and determines whether or not the charging completion signal is input. When the determination result is negative, the primary side control unit 14 determines (step S19) whether or not a predetermined charging time has elapsed from the charging starts (step S16). The charging time refers to a time that is sufficient for obtaining a fully charged state from a state in which the charging amount of the battery BA is null and is set through experiments.

When the determination result of step S19 is positive, the primary side control unit 14 determines that the charging is complete and ends the process. When the determination result of step S19 is negative, the primary side control unit 14 executes the process of step S17 again after a predetermined time elapses. When the determination result of step S18 is positive (when the charging completion signal is input), the primary side control unit 14 determines that the charging is complete and ends the process.

The control related to the charging of the battery BA when the portable device main body 200 includes the charging management unit 201 will now be with reference to FIG. 3. The control is basically the same as when the portable device main body 200 does not include the charging management unit 201. Thus, the control will not be described in detail and may not be completely illustrated in the drawings.

When in the standby state (not electromagnetically connected to the contactless power receiving device 20), the primary side control unit 14 outputs a device detection signal in predetermined detection cycles (step S10). The contactless power transmitting device 10 outputs the device detection signal and executes the device arrangement determination of determining whether or not the contactless power receiving device 20 is arranged (step S11). When a negative determination is made in the device arrangement determination (step S11), the primary side control unit 14 executes the process of step S10 again after a predetermined time elapses and outputs the device detection signal again. When the positive determination is made in the device arrangement determination (step S11), the primary side control unit 14 outputs the charge check signal to the power receiving device 20 (step S12).

The secondary side control unit 22 demodulates and analyzes the signal including “0” or “1” detected by the signal detection circuit 23. When determining that the charge check signal has been received, the secondary side control unit 22 determines the charging amount based on the voltage of the battery BA. Under the assumption that the charging management unit 201 is arranged in the portable device main body 200, the secondary side control unit 22 determines that charging is possible when the recharging request signal is input through the monitoring circuit 25 from the charging management unit 201. If charging is possible (voltage of the battery BA is less than or equal to the first recharge determination value), the secondary side control unit 22 outputs the first response signal (recharging request signal) in accordance with the charge check signal (step S21).

The primary side control unit 14 demodulates the signal based on the waveform of the induced electromotive force detected by the voltage detection circuit 13 and determines whether or not the first response signal is input (step S13). When the determination result is negative, the primary side control unit 14 executes the process of step S10 again after a predetermined time elapses. When the determination result of step S13 is positive, the primary side control unit 14 outputs the ID check signal indicating an ID to perform ID authentication (step S14).

When determining that the ID check signal has been received, the secondary side control unit 22 determines whether or not the ID is that of the chargeable device. When the ID is that of the chargeable device (contactless power transmitting device 10), the secondary side control unit 22 outputs the second response signal in correspondence with the ID check signal (step S22). The primary side control unit 14 determines whether or not the second response signal is input (step S15). When the determination result is negative (when the ID authentication is unsuccessful), the primary side control unit 14 executes the process of step S10 again after a predetermined time elapses. When the determination result of step S15 is positive, the primary side control unit 14 starts with the power for transmitting charging power (step S16). The secondary side control unit 22 starts the charging after the second response signal is output (step S23).

After the charging starts, the secondary side control unit 22 continues to monitor the charging amount and determines whether or not the charging is completed based on the voltage of the battery BA input from the monitoring circuit 25 (step S24). Specifically, the secondary side control unit 22 determines that the charging is completed when the charging completion signal is input through the monitoring circuit 25 from the charging management unit 201. When the determination result of step S24 is negative (when charging is not completed), the secondary side control unit 22 executes the process of step S24 again after a predetermined time elapses. When the determination result of step S24 is positive (when charging is completed), the secondary side control unit 22 outputs the charging completion signal indicating that the charging is completed to the contactless power transmitting device 10 (step S25).

After the process of step S16 (after starting charging), the primary side control unit 14 executes the device arrangement determination that determines whether or not the contactless power receiving device 20 is still remaining (step S17). When the device arrangement determination of step S17 is negative, the primary side control unit 14 proceeds to the process of step S10. When the device arrangement determination of step S17 is positive, the primary side control unit 14 determines whether or not the charging completion signal is input (step S18). When the determination result is negative, the primary side control unit 14 determines whether or not the predetermined time has elapsed (step S19) from when the charging starts (step S16).

When the determination result of step S19 is positive, the primary side control unit 14 determines that the charging is complete and ends the process. When the determination result of step S19 is negative, the primary side control unit 14 executes the process of step S17 again after the predetermined time elapses. When the determination result of step S18 is positive (when the charging completion signal is input), the primary side control unit 14 determines that the charging is complete and ends the process.

As described above in detail, the present embodiment has the advantages described below.

(1) The secondary side control unit 22 measures the voltage (charging amount) of the battery BA through the monitoring circuit 25 and determines whether or not to supply power to the battery BA based on the measured voltage. Thus, the battery BA is charged normally even when the portable device main body 200 does not include the charging management unit 201, which manages the charging amount of the battery BA. This prevents overcharging and allows for recharging to be performed accurately.

(2) When the charging management unit 201 is included, the secondary side control unit 22 manages the charging of the battery BA based on the control signal from the charging management unit 201. In other words, the charging management unit 201 monitors the voltage of the battery BA and outputs the recharging request signal to the secondary side control unit 22 through the monitoring circuit 25 when the voltage is less than or equal to the second recharging request signal. When the recharging request signal is input, the secondary side control unit 22 determines that charging can be performed and starts the charging. The charging management unit 201 monitors the voltage of the battery BA and outputs the charging completion signal to the secondary side control unit 22 through the monitoring circuit 25 when the voltage is greater than or equal to the second charging completion signal. When the charging completion signal is input, the secondary side control unit 22 determines that charging is unnecessary and terminates the charging. In this manner, in response to the control signal (recharging request signal or charging completion signal) from the device, the monitoring circuit 25 transmits the charging control signal (recharging request signal or charging completion signal), which is in correspondence with the control signal, to the secondary side control unit 22. As a result, the charging management unit 201 arranged in the portable device main body 200 executes the charging control so that the optimal charging management can be performed on the battery BA of the portable device main body 200.

(3) The charging management unit 201 outputs the charging completion signal when the voltage of the battery BA is greater than or equal to the second full charge determination value. The secondary side control unit 22 determines that the charging is unnecessary and outputs the charging completion signal when the voltage of the battery BA is greater than or equal to the first full charge determination value. The second full charge determination value is set as a value that is smaller than the first full charge determination value. Thus, the charging management unit 201 can determine that the charging is completed before the secondary side control unit 22, and priority can be given to the charging control executed by the charging management unit 201 for control related to the ending of charging. Accordingly, the charging management unit 201 arranged in the portable device main body 200 executes the charging control. Thus, the optimal charging management can be performed on the battery BA of the portable device main body 200.

(4) The charging management unit 201 outputs the recharging request signal when the voltage of the battery BA is less than or equal to the second recharge determination value, and the secondary side control unit 22 determines that charging is possible and outputs the recharging request signal when the voltage of the battery BA becomes less than or equal to the first recharge determination value. The second recharge determination value is set at a value that is greater than the first recharge determination value. Thus, the charging management unit 201 can determine that the charging is possible before than the secondary side control unit 22, and priority may be given to the charging control executed by the charging management unit 201 with regard to control related to whether or not the charging is possible. Accordingly, the charging control is executed by the charging management unit 201 arranged in the portable device main body 200. Thus, the optimal charging management for the battery BA of the portable device main body 200 can be performed.

The above embodiment may be modified as described below.

In the embodiment described above, the monitoring circuit 25 may be incorporated in the secondary side control unit 22.

In the embodiment described above, the portable device main body 200 may be a cellular phone, an electrical razor, an electrical toothbrush, a laptop computer, or the like.

In the embodiment described above, ID authentication is performed. However, ID authentication does not have to be performed.

In the embodiment described above, the primary side control unit 14 is included but does not have to be included. In this case, the contactless power transmitting device 10 starts charging when the device arrangement determination is positive. When the charging time is elapsed in a timer, the contactless power transmitting device 10 ends the charging. The contactless power receiving device 20 terminates the charging (terminate supply of charging power) when the voltage of the battery BA becomes greater than or equal to the first full charge determination value or the second full charge determination value.

In the embodiment described above, the primary side control unit 14 determines that the charging is completed when the predetermined charging time elapses from when charging starts in step S19. However, the charging may continue until receiving the charging completion signal or until the contactless power receiving device 20 is removed.

In the embodiment described above, the primary side control unit 14 may continue the charging until the predetermined charging time elapses from when charging starts.

In the embodiment described above, the first recharge determination value is set as a value that is smaller than the second recharge determination value but may be set as an value equal to the second recharge determination value. The first recharge determination value may be set at a value that is greater than the second recharge determination value.

In the embodiment described above, the first full charge determination value is set as a value that is greater than the second full charge determination value but may be set as a value equal to the second full charge determination value. The first full charge determination value may be set with a value smaller than the second full charge determination value.

In the embodiment described above, the contactless power receiving device 20 is formed as a battery cover but may be changed to any structure as long as it is removable from the portable device main body 200.

In the embodiment described above, when the signal control circuit 24 of the contactless power receiving device 20 executes the load modulation process, the primary side control unit 14 performs a determination on a signal based on whether or not the peak voltage exceeds the threshold value but may perform a determination on the signal based on whether or not the amount of change is greater than or equal to a constant amount.

In the embodiment described above, the secondary side control unit 22 receives drive power from the battery BA but may be supplied with drive power from the power receiving unit 21.

In the embodiment described above, when determining (positive determination) that the contactless power receiving device 20 is set in the device arrangement determination, the primary side control unit 14 outputs the charge check signal to the contactless power receiving device 20. However, the charge check signal may be output from the contactless power receiving device 20 to the contactless power transmitting device 10.

In the embodiment described above, the timing for determining the charging amount of the battery BA is before the output of the first response signal. However, the charging amount only needs to be determined before charging starts.

In the embodiment described above, when the charging amount is determined and charging is determined as being unnecessary, the process ends without outputting the first response signal. However, a response signal indicating that charging is unnecessary may be output to the contactless power transmitting device 10.

In the embodiment described above, when the ID authentication is unsuccessful (not chargeable device), the secondary side control unit 22 ends the process without outputting the second response signal but may output a response signal to the contactless power transmitting device 10 indicating that the ID authentication was unsuccessful (not chargeable device).

In the embodiment described above, the ID is determined by the secondary side control unit 22 but may be determined by the primary side control unit 14.

In the embodiment described above, when determining whether or not the contactless power receiving device 20 is still remaining (device arrangement determination) after charging starts, the primary side control unit 14 determines the power waveform of the primary coil L1 but may perform the determination by communicating a signal in predetermined cycles.

In the embodiment described above, the function of determining whether or not the predetermined charging time has elapsed when charging starts may be omitted.

1. A contactless power receiving device connected by a connection terminal to an equipment, wherein the contactless power receiving device supplies power to a load of the equipment, the contactless power receiving device comprising:
a secondary coil that intersects with an alternating magnetic flux generated from a primary coil, which is supplied with AC power; and
a control unit that supplies induced electromotive force of the secondary coil to the load,
wherein the control unit determines a charging amount of the load and determines whether or not to supply power to the load based on the determined charging amount.

2. The contactless power receiving device according to claim 1, wherein the control unit ends charging of the load when determining that a voltage of the load is greater than or equal to a predetermined first full charge determination value.

3. The contactless power receiving device according to claim 2, wherein
when the equipment includes a device side charging control unit that measures the voltage of the load, the control unit is configured to end the charging of the load when the device side charging control unit determines that the voltage of the load is greater than or equal to a predetermined second full charge determination value; and
the first full charge determination value is set as a value that is greater than the second full charge determination value.

4. The contactless power receiving device according to claim 1, wherein the control unit supplies power to the load when the voltage of the load is less than or equal to a predetermined first recharge determination value.

5. The contactless power receiving device according to claim 4, wherein
when the equipment includes a device side charging control unit that measures the voltage of the load, the control unit is configured to supply power to the load when the device side charging control unit determines that the voltage of the load is less than or equal to a predetermined second recharge determination value; and
the first recharge determination value is set as a value that is smaller than the second recharge determination value.

6. The contactless power receiving device according to claim 1, further comprising
a monitoring circuit connected to the control unit and connectable by the connection terminal to the equipment, wherein the monitoring circuit monitors a control signal provided from the equipment and transmits a charging control signal, which corresponds to the control signal provided from the equipment, to the control unit.

7. The contactless power receiving device according to claim 6, wherein the monitoring circuit is further configured to monitor the voltage of the load regardless of whether or not the control signal is provided from the equipment, and the monitoring circuit transmits the charging control signal, which corresponds to the control signal provided from the equipment, to the control unit regardless of a monitoring result of the voltage of the load when the control signal is provided from the equipment.

8. A contactless charging system comprising:
a contactless power transmitting device including a primary coil that generates an alternating magnetic flux when supplied with AC power; and
a contactless power receiving device including a secondary coil that intersects with the alternating magnetic flux generated from the primary coil, wherein the contactless power receiving device supplies the AC power, which is supplied from the primary coil through the secondary coil, to a load of an equipment connected by a connection terminal, wherein
the contactless power receiving device includes a control unit that supplies the load with an induced electromotive force of the secondary coil generated by intersecting the alternating magnetic flux generated from the primary coil; and
the control unit determines a charging amount of the load and determines whether or not to supply power to the load based on the determined charging amount.

9. The contactless power receiving device according to claim 2, wherein the control unit supplies power to the load when the voltage of the load is less than or equal to a predetermined first recharge determination value.

10. The contactless power receiving device according to claim 9, wherein
when the equipment includes a device side charging control unit that measures the voltage of the load, the control unit is configured to supply power to the load when the device side charging control unit determines that the voltage of the load is less than or equal to a predetermined second recharge determination value; and
the first recharge determination value is set as a value that is smaller than the second recharge determination value.

11. The contactless power receiving device according to claim 3, wherein the control unit supplies power to the load when the voltage of the load is less than or equal to a predetermined first recharge determination value.

12. The contactless power receiving device according to claim 11, wherein
when the equipment includes a device side charging control unit that measures the voltage of the load, the control unit is configured to supply power to the load when the device side charging control unit determines that the voltage of the load is less than or equal to a predetermined second recharge determination value; and
the first recharge determination value is set as a value that is smaller than the second recharge determination value.

13. The contactless power receiving device according to claim 2, further comprising
a monitoring circuit connected to the control unit and connectable by the connection terminal to the equipment, wherein the monitoring circuit monitors a control signal provided from the equipment and transmits a charging control signal, which corresponds to the control signal provided from the equipment, to the control unit.

14. The contactless power receiving device according to claim 13, wherein the monitoring circuit is further configured to monitor the voltage of the load regardless of whether or not the control signal is provided from the equipment, and the monitoring circuit transmits the charging control signal, which corresponds to the control signal provided from the equipment, to the control unit regardless of a monitoring result of the voltage of the load when the control signal is provided from the equipment.

15. The contactless power receiving device according to claim 3, further comprising
a monitoring circuit connected to the control unit and connectable by the connection terminal to the equipment, wherein the monitoring circuit monitors a control signal provided from the equipment and transmits a charging control signal, which corresponds to the control signal provided from the equipment, to the control unit.

16. The contactless power receiving device according to claim 15, wherein the monitoring circuit is further configured to monitor the voltage of the load regardless of whether or not the control signal is provided from the equipment, and the monitoring circuit transmits the charging control signal, which corresponds to the control signal provided from the equipment, to the control unit regardless of a monitoring result of the voltage of the load when the control signal is provided from the equipment.

17. The contactless power receiving device according to claim 4, further comprising
a monitoring circuit connected to the control unit and connectable by the connection terminal to the equipment, wherein the monitoring circuit monitors a control signal provided from the equipment and transmits a charging control signal, which corresponds to the control signal provided from the equipment, to the control unit.

18. The contactless power receiving device according to claim 17, wherein the monitoring circuit is further configured to monitor the voltage of the load regardless of whether or not the control signal is provided from the equipment, and the monitoring circuit transmits the charging control signal, which corresponds to the control signal provided from the equipment, to the control unit regardless of a monitoring result of the voltage of the load when the control signal is provided from the equipment.

19. The contactless power receiving device according to claim 5, further comprising
a monitoring circuit connected to the control unit and connectable by the connection terminal to the equipment, wherein the monitoring circuit monitors a control signal provided from the equipment and transmits a charging control signal, which corresponds to the control signal provided from the equipment, to the control unit.

20. The contactless power receiving device according to claim 19, wherein the monitoring circuit is further configured to monitor the voltage of the load regardless of whether or not the control signal is provided from the equipment, and the monitoring circuit transmits the charging control signal, which corresponds to the control signal provided from the equipment, to the control unit regardless of a monitoring result of the voltage of the load when the control signal is provided from the equipment.
